(19) United States
(12) Patent Application Publication
(10) Pub. No.: US 2019/0359328 A1
(43) Pub. Date: Nov. 28, 2019

(54) LARGE PAYLOAD UNMANNED AERIAL VEHICLE

(71) Applicant: FULCRUM UAV TECHNOLOGY INC., Foothills, AB (CA)

(72) Inventors: Daniel John CLARKE, Calgary (CA); Jason Peter CLARKE, Calgary (CA)

(21) Appl. No.: 16/348,532

(22) PCT Filed: Dec. 4, 2017
(86) PCT No.: PCT/CA2017/051458

§ 371 Date: May 9, 2019

Related U.S. Application Data
(60) Provisional application No. 62/430,150, filed on Dec. 5, 2016.

(51) Int. Cl. B64C 39/02; B64C 11/44; B64C 27/68; B64D 27/24

(52) U.S. Cl. CPC B64C 39/024; B64C 11/44; B64C 27/68; B64C 2201/16; B64C 2201/108; B64C 2201/128; B64D 27/24

(57) ABSTRACT

An unmanned aerial vehicle (“UAV”) is provided for the lifting and carrying payloads of up to 100 kg. The UAV can include a pair of counter-rotating propellers enclosed in a cage with attitude control motors for providing directional thrust mounted on the top of the cage. One or more motors can rotate the propellers via co-axially concentric vertical output shafts. The motor can include an internal combustion motor or an electric motor.

### CROSS-REFERENCE TO RELATED APPLICATIONS

This application claims priority of U.S. provisional patent application Ser. No. 62/430,150 filed Dec. 5, 2016, which is incorporated by reference into this application in its entirety.

### TECHNICAL FIELD

The present disclosure is related to the field of unmanned aerial vehicles (“drones”), in particular, drones capable of carrying large payloads.

### BACKGROUND

Unmanned aerial vehicles (“UAVs”), better known as drones, are one of the technological marvels of our age. They can document the aftermath of disasters without putting additional people at risk, and the corporate sector plan to use them for small package delivery in the not-too-distant future.

Large delivery and service companies have plans for turning drone technology into new sources of revenue. Amazon has announced its “Prime Air,” a delivery system it says will eventually allow the company to “to safely get packages into customers' hands in 30 minutes or less” using small drones. In 2014, DHL Parcel announced the start of regular, autonomous drone flights to a sparsely inhabited German island in the North Sea for scheduled deliveries of medications and “other urgently needed goods” to the local community. Google also has a drone delivery service called Wing in the works. Providing a drone for logistics applications still requires overcoming the problems of being able to carry large payloads over large distances and/or being able to operate for extended periods of time. Drones that can carry small payloads can flown over longer distances than drones carrying larger payloads due to the drain on the batteries required for the additional power needed to lift the larger payloads.

It is, therefore, desirable to provide a drone that overcomes the limited payload carrying capability of existing drone technology.

### SUMMARY

An unmanned aerial vehicle (“UAV”) capable of carrying large payloads is provided.

In some embodiments, the UAV can comprise a pair of counter-rotating upper and lower propellers enclosed in a cage, similar in construction to a bicycle wheel, powered by one or more motors that can comprise internal combustion motors or electric motors. In some embodiments, the UAV can comprise an internal combustion engine driven electrical generator that can be in place of, or in combination with, batteries for powering the electric motors on the UAV.

In some embodiments, located at the top of the cage, the UAV can comprise a plurality of attitude control motors coupled to propellers to provide thrust in a lateral direction. In some embodiments, concentric coaxial output shafts can provide coupling between the motors and the propellers. In some embodiments, each propeller can comprise a pitch control mechanism configured for adjusting the pitch of the propeller's rotors. With respect to the lower propeller, its pitch control mechanism can be disposed on the frame of the UAV, beneath the lower propeller. With respect to the upper propeller, its pitch control mechanism can be disposed on the output shaft rotating the upper propeller, the upper propeller's pitch control mechanism disposed above the upper propeller.

Broadly stated, in some embodiments, an unmanned aerial vehicle (“UAV”) can be provided, comprising: at least one motor operatively coupled to at least one propeller via at least one substantially vertical output shaft, the at least one propeller configured to provide vertical lift to the UAV when the at least one motor is operating, the at least one propeller comprising at least one rotor; a support frame configured to support the at least one motor and the at least one propeller; and a cage operatively coupled to the support frame, the cage configured to enclose the at least one propeller.

Broadly stated, in some embodiments, the UAV can further comprise at least one attitude control motor disposed on an upper portion of the cage, the at least one attitude control motor configured to provide attitude thrust to the UAV.

Broadly stated, in some embodiments, the at least one attitude control motor can be configured to provide thrust in more than one attitude direction.

Broadly stated, in some embodiments, the at least one attitude control motor can further comprise three attitude control motors disposed on the upper portion, the three attitude control motors spaced substantially equidistant apart from each other.

Broadly stated, in some embodiments, the at least one attitude control motor can further comprise four attitude control motors disposed on the upper portion, the four attitude control motors spaced substantially equidistant apart from each other.

Broadly stated, in some embodiments, the cage can further comprise: a lower ring operatively coupled to the support frame; an upper ring disposed above the lower ring, the upper ring substantially co-axially aligned with the lower ring; at least one guard ring disposed between the upper ring and the lower ring, the at least one guard ring substantially co-axially aligned with the upper and lower rings; and a plurality of spokes operatively coupling the at least one guard ring to the upper ring and to the lower ring.

Broadly stated, in some embodiments, the at least one guard ring can comprise an upper guard ring and a lower guard ring spaced-apart from each other by a plurality of substantially vertical spaced-apart struts, and wherein the plurality of spokes comprises a plurality of upper spokes operatively coupling the upper ring to the upper guard ring and a plurality of lower spokes operatively coupling the lower ring to the lower guard ring.

Broadly stated, in some embodiments, the at least one motor can comprise at least one internal combustion motor.

Broadly stated, in some embodiments, the at least one motor can comprise at least one electric motor.

Broadly stated, in some embodiments, the UAV can further comprise at least one battery operatively coupled to the at least one electric motor.

Broadly stated, in some embodiments, the UAV can further comprise at least one pitch control mechanism operatively coupled to the at least one propeller, the at least one pitch control mechanism configured to adjust pitch of the at least one rotor.

Broadly stated, in some embodiments, the at least one propeller can comprise an upper propeller disposed above a lower propeller, the upper propeller operatively coupled to an upper output shaft and the lower propeller operatively coupled to a lower output shaft, the upper output shaft substantially aligned and nested within the lower output shaft, the upper and lower propellers configured to rotate in opposite directions relative to each other.

Broadly stated, in some embodiments, the UAV can further comprise an upper pitch control mechanism operatively coupled to the upper propeller.

Broadly stated, in some embodiments, the upper pitch control mechanism can further comprise a pushrod disposed within the upper output shaft, the pushrod operatively coupled to a sleeve slidably disposed around the upper output shaft by a guide pin passing through slots disposed through sidewalls of the upper output shaft whereby the sleeve is configured to move up and down relative to the upper output shaft as the pushrod moves up and down, the sleeve operatively coupled to a rotor shaft configured to adjust the pitch of the upper propeller as the pushrod moves up and down.

Broadly stated, in some embodiments, the UAV can further comprise a lower pitch control mechanism operatively coupled to the lower propeller.

Broadly stated, in some embodiments, the lower pitch control mechanism can comprise a lower crank operatively coupled to a lower sleeve slidably disposed around the lower output shaft whereby the lower sleeve is configured to move up and down relative to the lower output shaft as the lower crank moves up and down, the lower sleeve operatively coupled to at least one lower rotor shaft configured to adjust the pitch of the lower propeller as the lower sleeve moves up and down.

Broadly stated, in some embodiments, the support frame can comprise a motor plate operatively coupled to a first end of the at least one motor and at least one torque reaction arm operatively coupled to a second end of the at least one motor, the at least one torque reaction arm operatively coupled to the support frame by at least one linkage.

### BRIEF DESCRIPTION OF THE DRAWINGS:

FIG. 1 is a perspective view depicting of one embodiment of a large payload carrying unmanned aerial vehicle (“UAV”) without a protective cage.

FIG. 2 is a top plan view depicting the UAV of FIG. 1 with a protective cage.

FIG. 3 is a perspective view depicting the UAV of FIG. 2.

FIG. 4 is a close-up perspective view depicting Detail A of FIG. 3.

FIG. 5 is a side elevation view depicting the UAV of FIG. 3.

FIG. 6 is a front elevation view depicting the UAV of FIG. 3.

FIG. 7 is an exploded perspective view depicting the UAV of FIG. 3.

FIG. 8 is a perspective view depicting one embodiment of a motor system for use in the UAV of FIG. 1.

FIG. 9 is a top plan view depicting the motor system of FIG. 8.

FIG. 10 is a side elevation view depicting the motor system of FIG. 8.

FIG. 11 is a front elevation view depicting the motor system of FIG. 8.

FIG. 12 is a side cross-section elevation view depicting the motor system of FIG. 11 along section lines A-A.

FIG. 13 is a perspective view depicting one embodiment of an upper rotor pitch servo system for use in the UAV of FIG. 1.

FIG. 14 is a top plan view depicting the upper rotor pitch servo system of FIG. 13.

FIG. 15 is a side elevation view depicting the upper rotor pitch servo system of FIG. 13.

FIG. 16 is a front elevation view depicting the upper rotor pitch servo system of FIG. 13.

FIG. 17 is a perspective view depicting one embodiment of a lower rotor pitch servo system for use in the UAV of FIG. 1.

FIG. 18 is a top plan view depicting the lower rotor pitch servo system of FIG. 17.

FIG. 19 is a side elevation view depicting the lower rotor pitch servo system of FIG. 17.

FIG. 20 is a front elevation view depicting the lower rotor pitch servo system of FIG. 17.

FIG. 21 is a side elevation view depicting the output drive system for the UAV of FIG. 1.

FIG. 22 is a side elevation cross-section view depicting the output drive system of FIG. 21 along section lines A-A.

FIG. 23 is a side elevation view depicting the upper output shaft of FIG. 21.

FIG. 24 is a side elevation view depicting one embodiment of an attitude control motor for use in the UAV of FIG. 1.

FIG. 25 is a front elevation view depicting the attitude control motor of FIG. 24.

FIG. 26 is a perspective view depicting the attitude control motor of FIG. 24.

FIG. 27 is a side elevation view depicting one embodiment of a battery pack for use in the UAV of FIG. 1.

FIG. 28 is a front elevation view depicting the battery pack of FIG. 27.

FIG. 29 is a perspective view depicting the battery pack of FIG. 27.

FIG. 30 is a perspective view depicting one embodiment of a protective cage for use on the UAV of FIG. 1.

FIG. 31 is a top plan view depicting the protective cage of FIG. 30.

FIG. 32 is a side elevation depicting the protective cage of FIG. 30.

FIG. 33 is a block diagram depicting one embodiment of an electrical wiring diagram for the UAV of FIGS. 1 to 32.

FIG. 34 is a perspective view depicting an alternate embodiment of an upper pitch control mechanism for use with the UAV of FIGS. 1 to 32.

FIG. 35 is a top plan view depicting the upper pitch control mechanism of FIG. 34.

FIG. 36 is an elevation view depicting the upper pitch control mechanism of FIG. 34.

FIG. 37 is an elevation cross-section view depicting the output drive system of FIG. 35 along section lines A-A.

FIG. 38 is a a block diagram depicting one embodiment of a control system for the UAV of FIGS. 1 to 32 and 34 to 37.

### DETAILED DESCRIPTION OF EMBODIMENTS:

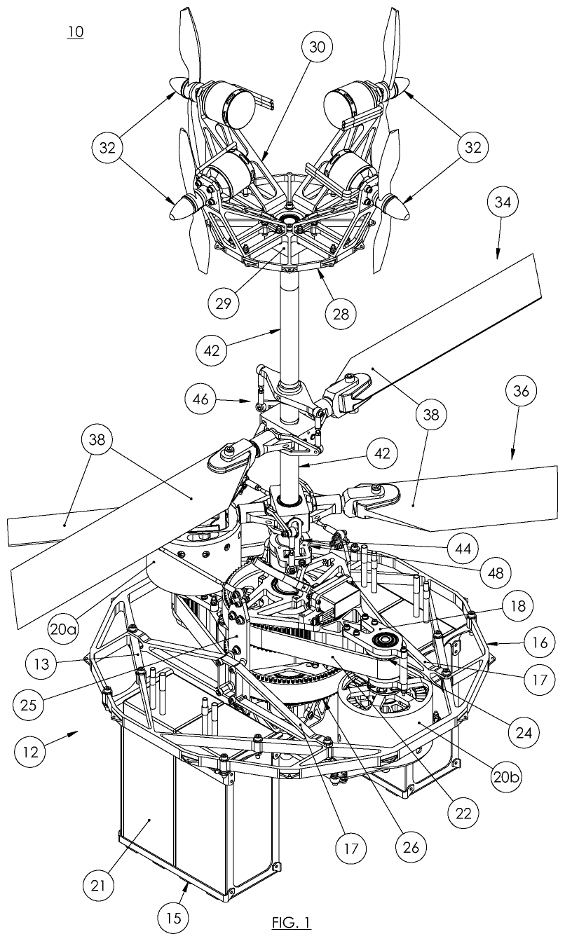

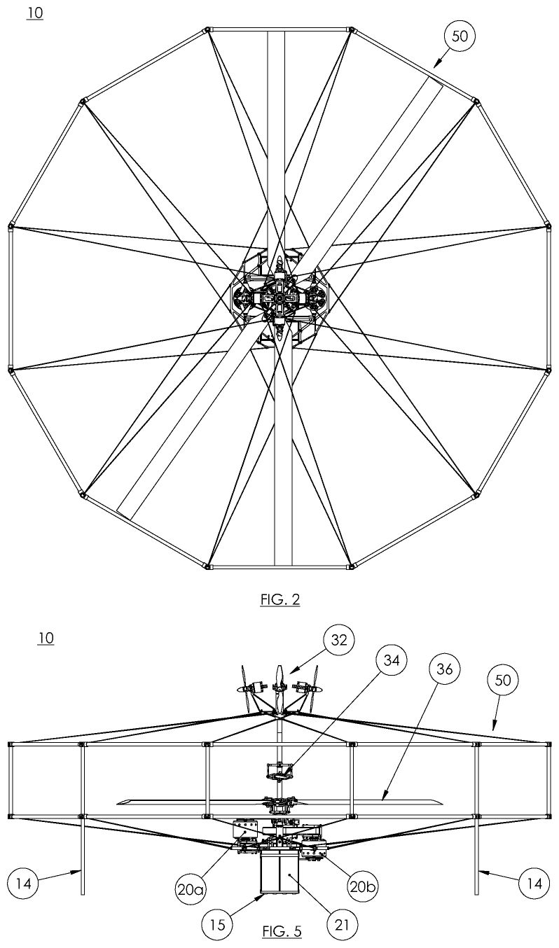

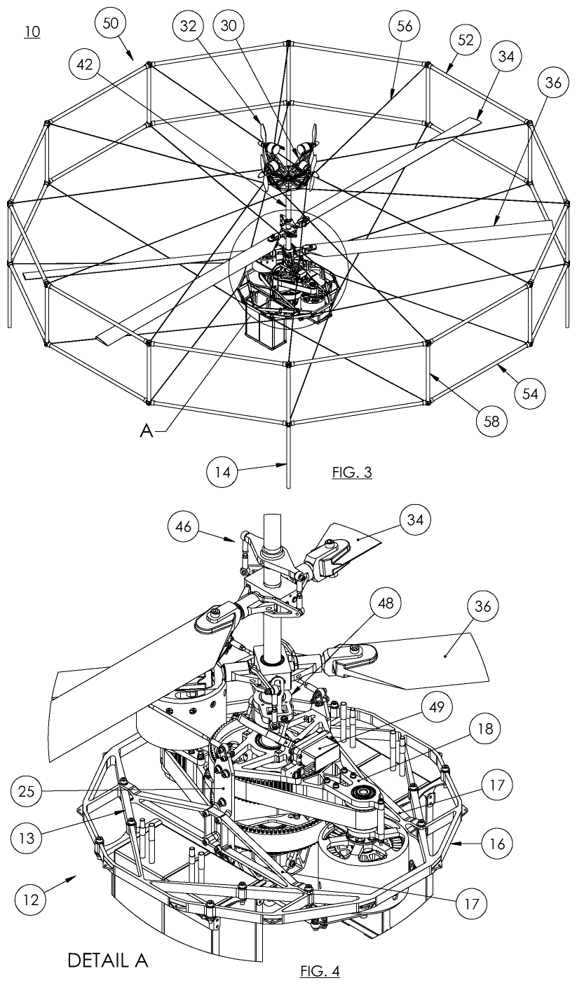

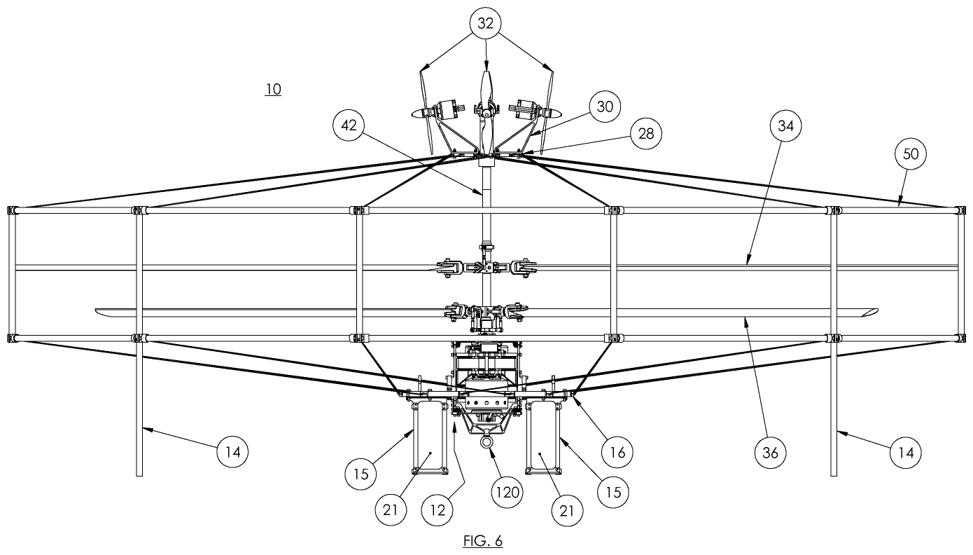

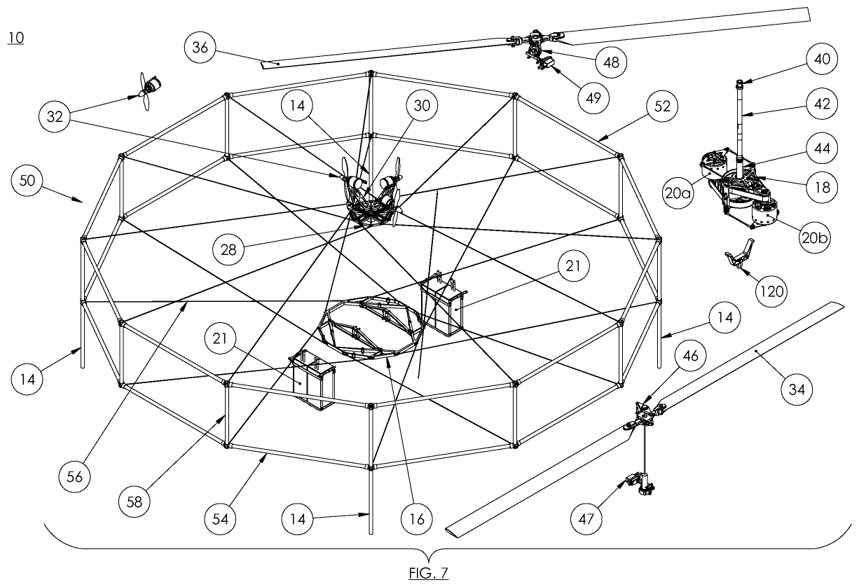

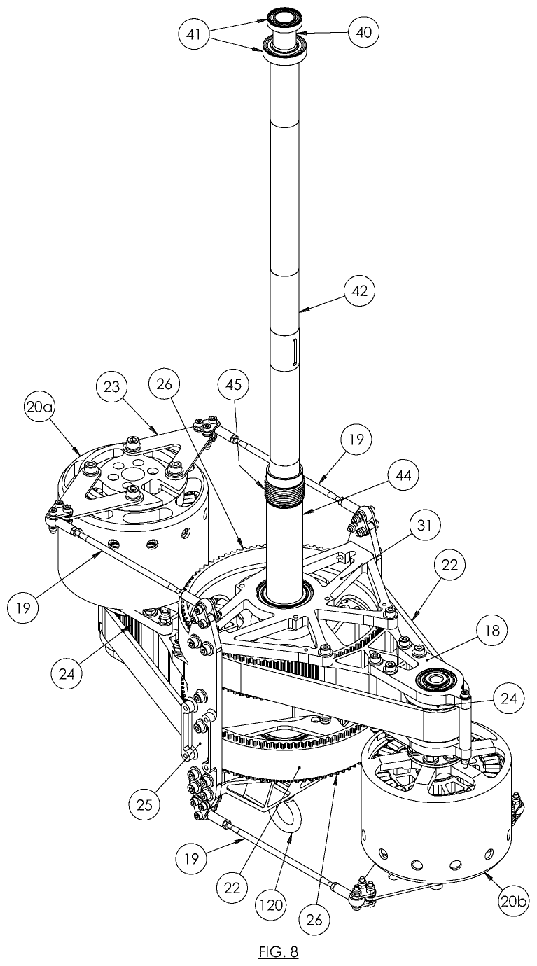

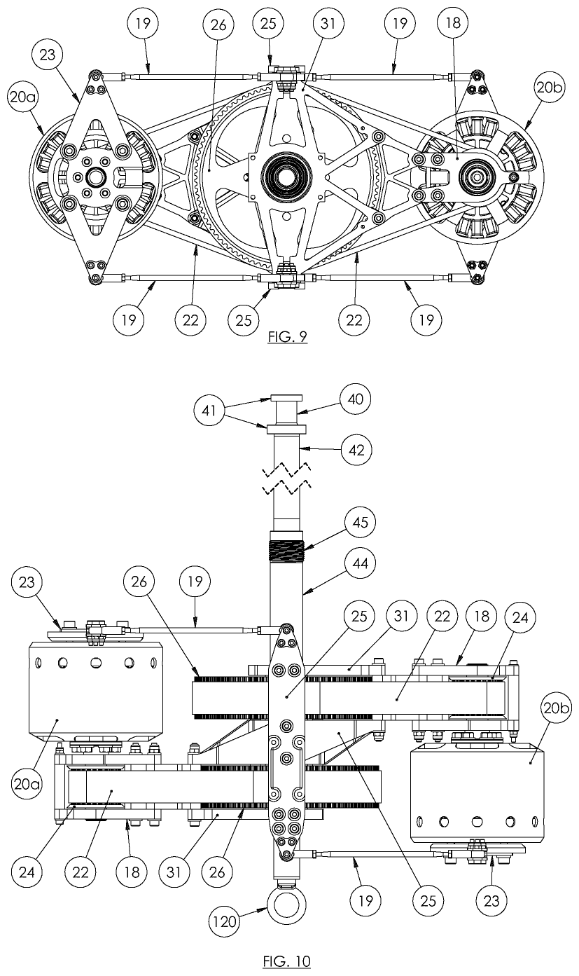

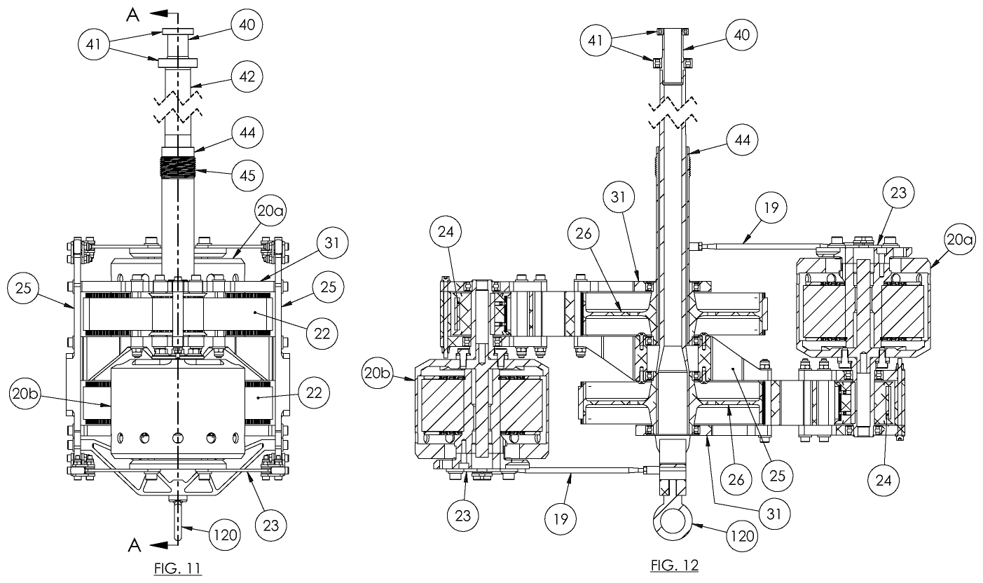

Referring to FIGS. 1 to 12, one embodiment of UAV 10 is shown without its protective cage installed. In some embodiments, UAV 10 can comprise of support frame 12 that can be comprised, generally, of lower ring 16, web strength members 13, struts 17, motor support frame 18 and vertical frame members 25. In some embodiments, frame 12 can further comprise cargo hook 120, as shown in FIG. 6, configured to attach a payload to.

In some embodiments, motor support frame 18 can comprise one or more motors disposed thereon, the motors operatively coupled to one or more output shaft. In some embodiments, UAV 10 can comprise tubular upper output shaft 42 substantially coaxially aligned and nested within tubular lower output shaft 44. UAV 10 can comprise motor 20b coupled to lower output shaft 44 via motor gear 24 and shaft gear 26 coupled together by belt 22, wherein lower output shaft 44 can be configured to rotate lower propeller 36. Similarly, UAV 10 can comprise motor 20a coupled to upper output shaft 42 via another set of motor gear 24, shaft gear 26 and belt 22, wherein upper output shaft 42 can be configured to rotate upper propeller 34 and wherein lower output shaft 44 can be concentrically disposed around upper output shaft 42 such that lower output shaft can rotate about upper output shaft 42, and wherein output shafts 42 and 44 can rotate in opposite angular directions relative to each other, thus resulting in upper propeller 34 and lower propeller 36 rotating in opposite angular directions relative to each other. In some embodiments, upper propeller 34 can rotate clockwise when viewed from above, whereas lower propeller 36 can rotate counter clockwise when viewed from above although it is obvious to those skilled in the art that these angular directions can be reversed with corresponding changes to the motor drive mechanisms described herein to enable the same.

In the illustrated embodiment, each of upper propeller 34 and lower propeller 36 can be comprised of carbon fibre. In some embodiments, each of the propellers can comprise model NACA 16-010 airfoils as manufactured by 4Front Robotics of Calgary, Alberta, Canada, wherein the airfoil can have a symmetrical cross-section profile, have a 75 mm chord, have a thickness ratio of 10% and have a blade length of 1050 mm from drag hinge axis to blade tip.

In some embodiments, vertical frame members 25 can couple to upper and lower motor support frames 18 to stabilize the combined structure. Motors 20a and 20b can be further supported by linkages 19 operatively coupling torque reaction arms 23 to vertical frame members 25. In some embodiments, motors 20a and 20b can comprise an internal combustion motor, the type, configuration, size and power, as obvious to those skilled in the art, sufficient to provide the aerial lift required to lift and fly UAV 10 plus a payload having a mass of up to 100 kg. In some embodiments, UAV 10 can comprise an internal combustion engine driven electrical generator that can be in place of, or in combination with, batteries for powering the electric motors on the UAV. As an example, a horizontally-opposed, 2-cylinder, air-cooled 250 cc 2 stroke engine of approximately 21 kW output coupled to a permanent magnet generator of approximately 19 kW of electrical power output can be positioned underneath the frame of UAV 10, nested between batteries 21.

In other embodiments, motors 20a and 20b can comprise an electric motor. In a representative embodiment, motor 20a and motor 20b can comprise a Predator 37-06 model electric motor as manufactured by Plettenberg Elektromotoren of Baunatal, Germany, wherein motor gear 24 can comprise a 25 tooth pulley and shaft gear 26 can comprise a 90 tooth pulley coupled together by belt 22 further comprising a 5×25×535 GT2 synchronous belt as manufactured by Gates Corporation of Denver, Colo., USA. In some embodiments, each of motors 20a and 20b can develop 15 kilowatts of power, thus, it is calculated that the combination of motors 20a and 20b and upper and lower propellers 34 and 36 can generate thrust up to 160 kgf thereby indicating a maximum payload carrying capacity of approximately 100 kg for UAV 10, as shown in the illustrated embodiment.

In embodiments where each of motor 20a and motor 20b comprises an electric motor, power can be provided to the motors by one or more battery modules 21 configured to be positioned within battery frames 15 disposed in support frame 12, wherein battery modules 21 can be operatively coupled to motors 20a and 20b to provide electric power thereto via a power control system as shown in FIG. 33 and described in further detail below.

In some embodiments, UAV 10 can comprise cage 50 operatively coupled to lower ring 16 to enable the enclosing of upper propeller 34 and lower propeller 36, wherein cage 50 can be operatively coupled to upper ring 28. Upper ring 29 can further comprise sleeve 29 that can be rotatably supported about centre shaft 40 via support bearings 41. In some embodiments, cage 50 can further comprise landing gear 14 attached thereto to support UAV 10 on the ground.

In some embodiments, UAV 10 can be configured to adjust the pitch of the rotors of each of propellers 34 and 36 to adjust the rate of lift of UAV 10, as well known to those skilled in the art. In some embodiments, the pitches of upper propeller 34 and lower propeller 36 can be controlled individually to provide differential lift therefrom, which can result in yaw motion of UAV 10 and, thus, facilitating steering control of UAV 10. Upper pitch control mechanism 46 can adjust the rotor pitch of upper propeller 34 whereas lower pitch control mechanism 48 can adjust the rotor pitch of lower propeller 36. As shown in the figures, in some embodiments, upper pitch control mechanism 46 can be disposed on upper output shaft 42 above upper propeller 34, whereas lower pitch control mechanism 48 can be disposed on frame member 31.

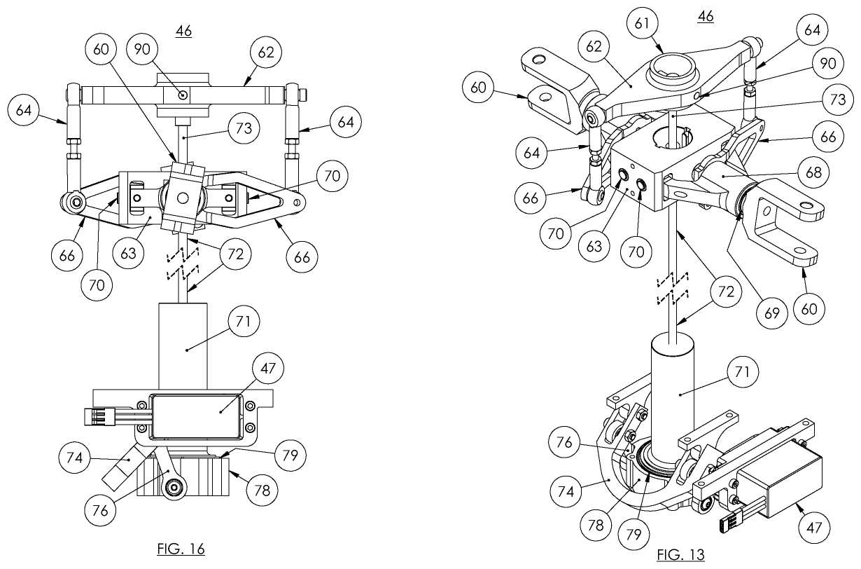

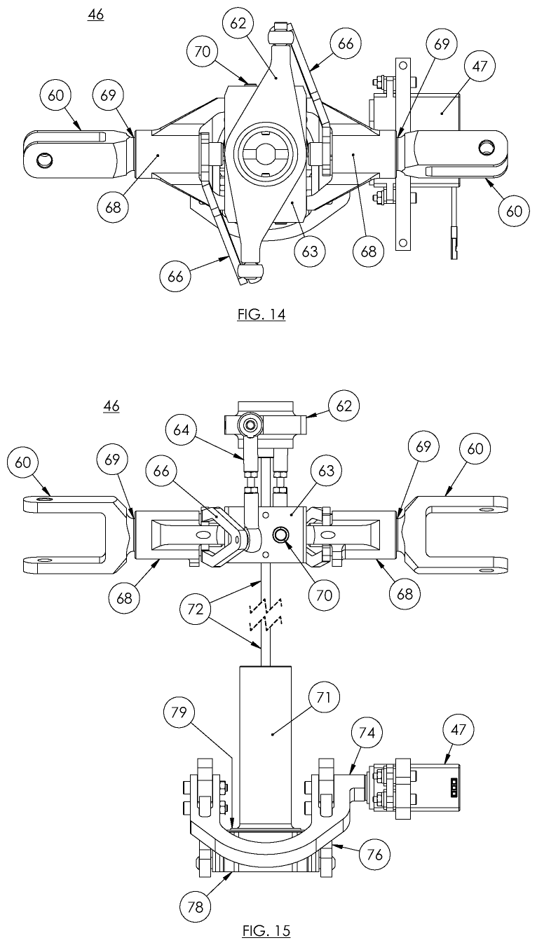

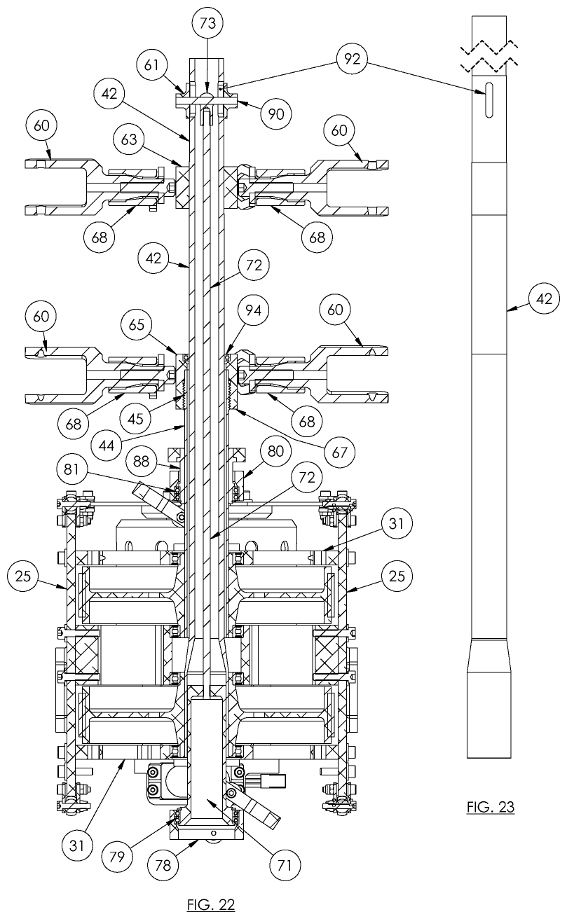

Referring to FIGS. 13 to 16, one embodiment of upper pitch control mechanism 46 is illustrated. In some embodiments, upper pitch control mechanism 46 can comprise a pair of blade mounts 60, each blade mount configured to receive blade rotors 38 to form upper propeller 34. Each blade mount 60 can further comprise shaft 69 rotatably disposed through rotor hub 68, wherein each rotor hub 68 can, in turn, be hingeably attached to flapping hinges 70. Thereby, flapping hinges 70 can operatively couple blade mounts 60 to collar 63 that, in turn, can be operatively attached to upper output shaft 42 thereby enabling upper propeller 34 to rotate when upper output shaft 42 rotates. In some embodiments, upper pitch control mechanism 46 can comprise crank arm 66 that can operatively couple shaft 69 to control arm 62 via linkage 64. In some embodiments, control arm 62 can be operatively coupled to pushrod 72, which can be raised and lowered by base 78. This is shown in more detail in FIGS. 21 to 23. In some embodiments, control arms 62 can extend outwardly from upper sleeve 61 that can, in turn, comprise guide pin 90 extending therethrough to operatively couple upper sleeve 61 and collar 62 to upper end 73 of pushrod 72. In so doing, guide pin 90 can pass through guide pin slots 92 disposed through the sidewalls of upper output shaft 42 enabling upper sleeve 61 to be able to move up and down relative to upper output shaft 42 as pushrod 72 moves up and down.

In some embodiments, a lower end of pushrod 72 can be operatively coupled to mandrel 71 that can be rotatably coupled to base 78 via bearing 79. In some embodiments, base 78 can be operatively coupled to one or more upper pitch servo motors 47 via upper crank 74 and links 76. Thus, upper pitch servo motors 47, upon receiving a first control signal, can rotate upper crank 74 to raise pushrod 72 to raise control arm 62. In so doing, linkage 64 can pull up on crank arms 66 to rotate shafts 69 thus decreasing the pitch of the rotors of upper propeller 34 as it rotates clockwise, as shown in the illustrated embodiment. Similarly, upper pitch servo motors 47, upon receiving a second control signal, can rotate upper crank 74 to lower pushrod 72 to lower control arm 62. In so doing, linkage 64 can push down on crank arms 66 to rotate shafts 69 thus increasing the pitch of the rotors of upper propeller 34.

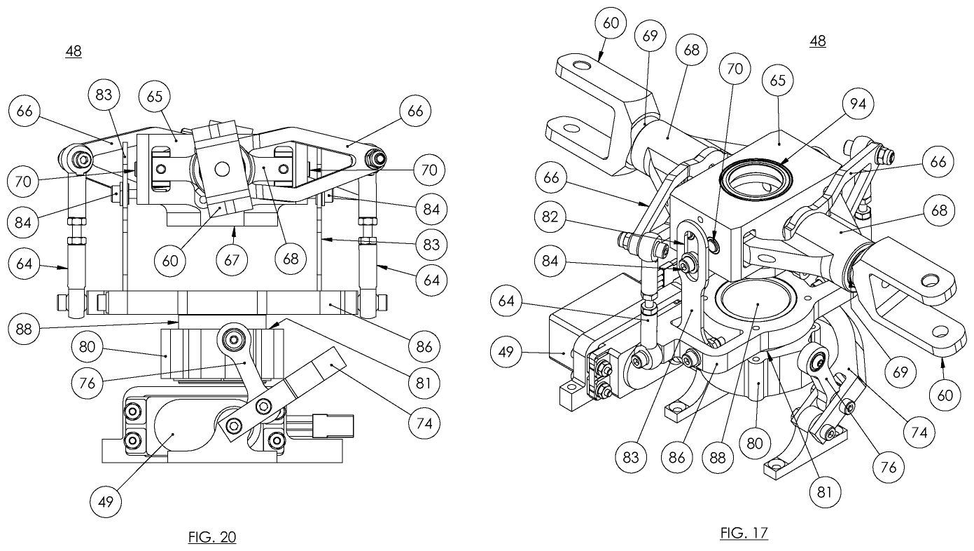

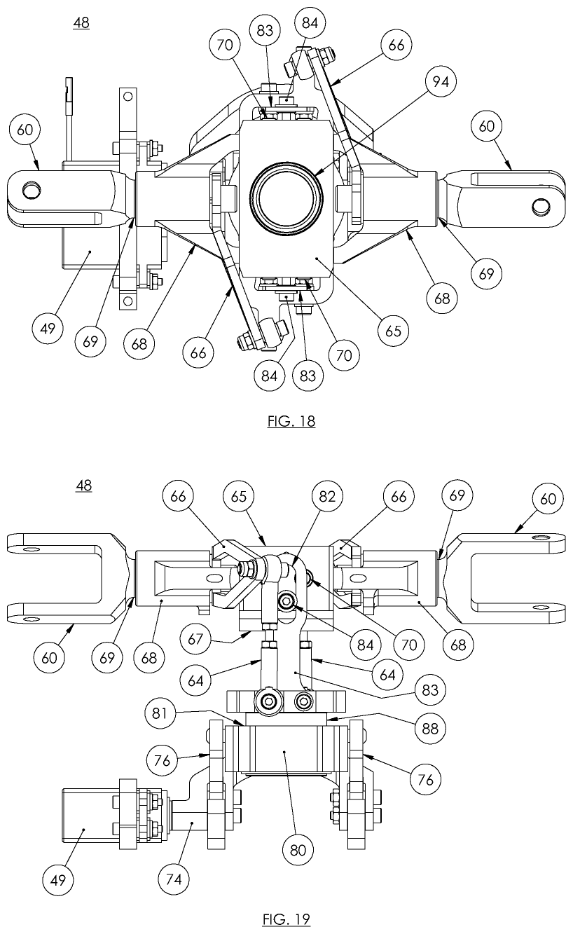

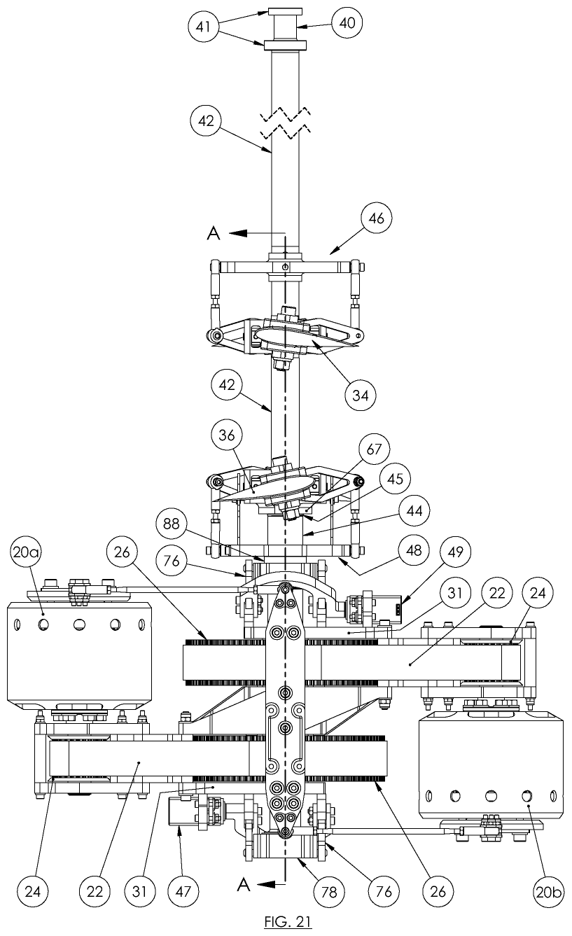

Referring to FIGS. 17 to 20, one embodiment of lower pitch control mechanism 48 is illustrated. In some embodiments, lower pitch control mechanism 48 can comprise a pair of blade mounts 60, each comprising a shaft 69 rotatably disposed through rotor hubs 68, wherein each rotor hub 68 can, in turn, be hingeably attached to flapping hinges 70. Blade mounts 60 of lower pitch control mechanism 48 can be configured to receive blade rotors 38 to form lower propeller 36. In some embodiments, threaded end 45 of lower output shaft 44 (as shown in FIGS. 8, 10 and 21) can thread into threaded receiver 67 disposed on the lower side of collar 65 although other fastening methods as well known to those skilled in the art can be used to couple lower output shaft 44 to collar 65. In embodiments where lower propeller 36 rotates clockwise (when viewed from above), left-handed threads can be used to threadably couple threaded end 45 to receiver 67 whereas in embodiments where lower propeller 36 rotates counter clockwise (when viewed from above), right-handed threads can be used to threadably couple threaded end 45 to receiver 67.

In some embodiments, flapping hinges 70 can operatively couple rotor hubs 68 to collar 65 whereby rotation of lower output shaft 44 can rotate collar 65 and, thus, rotate lower propeller 36. In some embodiments, collar 65 can comprise support bearing 94 that can support upper output shaft 42 disposed therethrough where upper output shaft 42 can rotate within support bearing 94.

In some embodiments, each blade mount 60 can be operatively coupled to shaft 69, which can then be operatively coupled to crank arm 66, which can further be coupled to control arm 86 via linkage 64. Control arm 86 can be operatively coupled to lower sleeve 88, which can be rotatably and slidably disposed around lower output shaft 44, lower sleeve 88 rotatably attached to base 80 via bearing 81. Control arm 86 can further comprise guide support member 83 that can further comprise slot 82 for receiving guide pin 84 operatively attached to collar 65. Base 80 can be operatively coupled to one or more lower pitch servo motors 49 via lower crank 74 and links 76. Thus, lower pitch servo motors 49, upon receiving the first control signal, can rotate lower crank 74 to raise base 80 to raise control arm 86. In so doing, linkage 64 can push up on crank arms 66 to rotate shafts 69 thus increasing the pitch of the rotors of lower propeller 36 as it rotates counter clockwise, as shown in the illustrated embodiment. Similarly, lower pitch servo motors 49, upon receiving the second control signal, can rotate upper crank 74 to lower base 80 to lower control arm 86. In so doing, linkage 64 can pull down on crank arms 66 to rotate shafts 69 thus decreasing the pitch of the rotors of lower propeller 36.

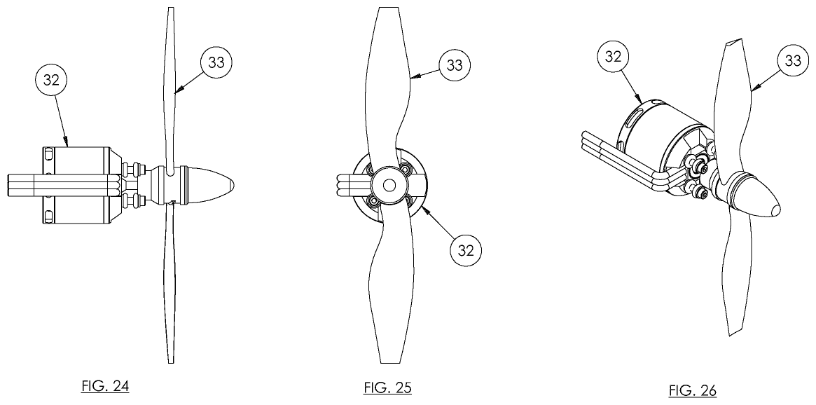

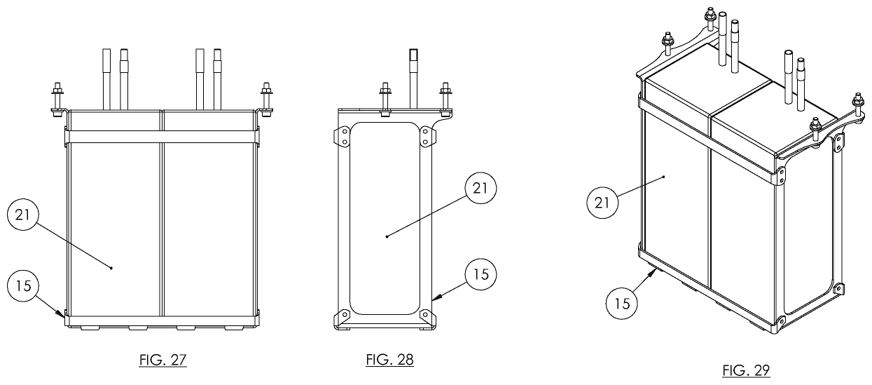

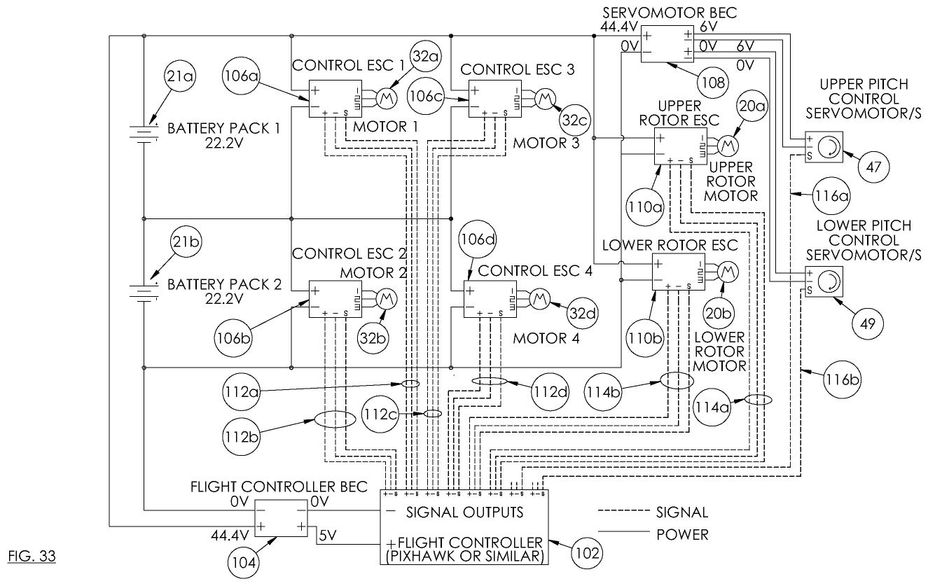

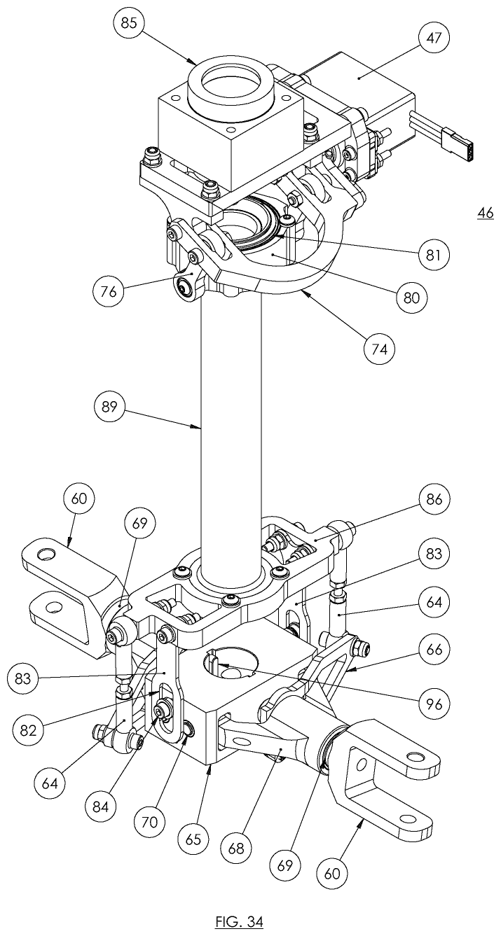

Referring to FIGS. 24 to 26, one embodiment of attitude control motor 32 is illustrated. In some embodiments, attitude control motor 32 can comprise a Scorpion HK-3020 brushless DC electric motor as manufactured by Scorpion Power System Ltd. of Hong Kong. In some embodiments, attitude control motor 32 can comprise propeller 33. Propeller 33 can comprise a 7×4E model propeller as manufactured by APC Propellers of California, U.S.A. One or more attitude control motors 32 can be operatively attached to motor mount 30 as shown in FIGS. 30 to 32. In the illustrated embodiment, four attitude control motors 32 can be placed substantially equidistant apart about motor mount 30 to provide attitude thrust side to side, or fore to aft, when UAV 10 is flying, although it is obvious to those skilled in the art that the number of attitude control motors 32 can be less or more than four. Thus, lateral thrust can be provided by either varying the rotational speed of one or more attitude control motors 32, or by varying the rotational speed of one or both of propellers 34 and 36, or a combination of the two. In addition, as the thrust vectors of each of attitude control motors 32 is offset from the center of gravity of UAV 10, operation of opposing attitude control motors 32, as shown in the illustrated embodiment, can rotate UAV 10 about its pitch or roll axes, thus facilitating pitch and roll angle control in addition to direct lateral maneuvering of UAV 10. In some embodiments, electrical power to attitude control motors 32 can be provided by routing electrical wires operatively coupled to batteries 21 along and around the periphery of cage 50.

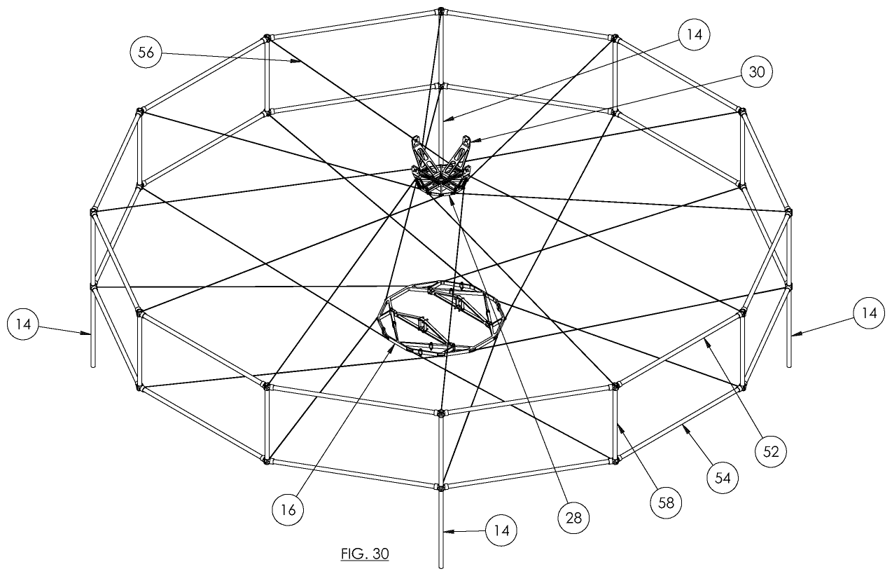

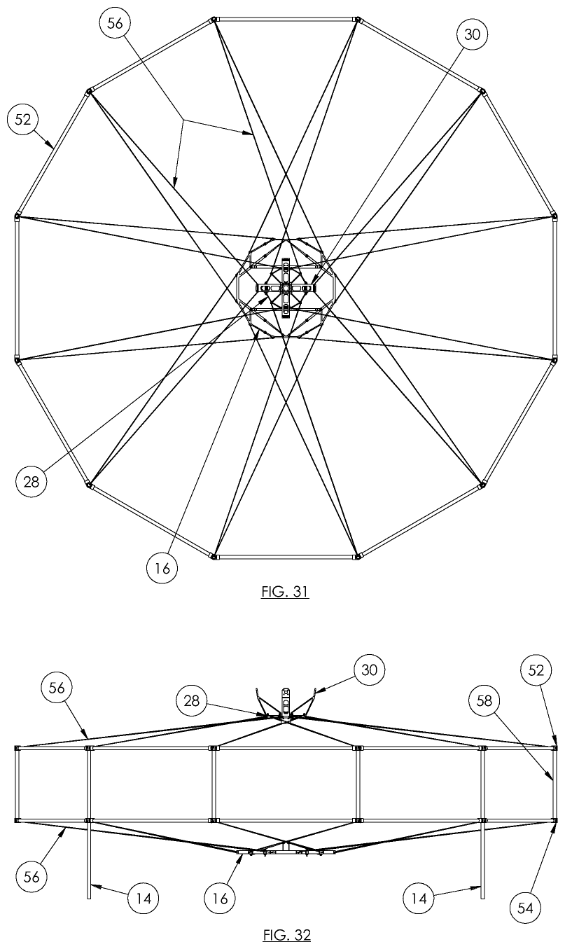

Referring to FIGS. 27 to 29, one embodiment of battery 21 is shown. In some embodiments, battery 21 can comprise a plurality of battery cells. In the illustrated embodiment, battery 21 can comprise two 16,000 milliamp-hour (“mAh”) Lithium Polymer 15C model battery cells as manufactured by Turnigy Power Systems of Hong Kong, each having an output voltage of 22.2 volts. In some embodiments, the two batteries can be connected in parallel to provide a combined output voltage of 22.2 volts with a capacity of 32,000 mAh whereas in other embodiments, the two batteries can be connected in series to provide a combined output voltage of 44.4 volts with a capacity of 16,000 mAh, depending on the power requirements for any particular configuration of UAV 10. It is obvious to those skilled in the art that batteries of different output voltage and amp-hour capacity can be used, depending on the size of UAV 10 and the load to be carried by UAV 10. In some embodiments, the individual battery cells can be placed in battery frame 15, as shown in FIG. 1.

Referring to FIGS. 30 to 32, one embodiment of cage 50 is shown. In some embodiments, cage 50 can comprise upper guard ring 52 and lower guard ring 54 separated by struts 58, wherein upper guard ring 52 can be coupled to upper ring 28 with spokes 56 and wherein lower guard ring 54 can be coupled to lower ring 16 with spokes 56. In some embodiments, spokes 56 can be configured in a semi-tangential lacing pattern similar to that of a bicycle wheel. The illustrated embodiment of cage 50 can provide light-weight rigidity to UAV 10 and still provide a protection barrier between bystanders and rotating propellers 34 and 36.

Referring to FIG. 33, an electrical schematic of one embodiment of a power management and control system for use with UAV 10 is illustrated, represented by reference numeral 100. In some embodiments, power system 100 can comprise a pair of batteries 21, each having a nominal output voltage of 22.2 volts, wired together in a series configuration. In the illustrated configuration, electrical power can be provided to electronic components of UAV 10 at 22.2 volts or 44.4 volts, depending on the power and voltage requirements of the electronic component.

In some embodiments, battery pack 21a can supply electrical current at 22.2V to Electronic Speed Controllers (“ESC”) 106a and 106c that can, in turn, supply electrical current at variable voltage to control motors 32a and 32c. Likewise, battery pack 21b can supply electrical current at 22.2V to ESCs 106b and 106d that can, in turn, supply electrical current at variable voltage to control motors 32b and 32d. By varying the voltage supplied to control motors 32a through 32d, the speed and, thus, thrust of the control propellers can be controlled.

In some embodiments, battery packs 21a and 21b, when connected in a series configuration, can supply electrical current at 44.4V to servomotor Battery Eliminating Circuit (“BEC”) 108, which can regulate the voltage down to supply electrical current at 6V to the upper pitch control servo motor 47 (one or more servo motors can be used for redundancy) and lower pitch control servo motor 49 (likewise, one or more servo motors can be used for redundancy).

In some embodiments, battery packs 21a and 21b, when connected in a series configuration, can supply electrical current at 44.4V to upper rotor ESC 110a that can supply electrical current at variable voltage to upper rotor motor 20a. In some embodiments, upper rotor ESC 110a can be configured to include the functionality of an electronic governor so as to provide the ability to maintain a relatively constant angular velocity for upper propeller 34 regardless of the pitch angle of upper propeller 34 or the torque applied thereto. Similarly, lower rotor ESC 110b can also be configured to include the functionality of an electronic governor so as to provide the ability to maintain a relatively constant angular velocity for lower propeller 36 regardless of the pitch angle of lower propeller 36 or the torque applied thereto.

Likewise, battery packs 21a and 21b, when connected in a series configuration, can supply electrical current at 44.4V to lower rotor ESC 110b that can supply electrical current at variable voltage to lower rotor motor 20b.

In some embodiments, battery packs 21a and 21b, when connected in a series configuration, can supply electrical current at 44.4V to flight controller BEC 104 that can supply current at 5V to flight controller 102. In a representative embodiment, flight controller 102 can comprise a Pixhawk model autopilot flight controller, an open source hardware project operated by the Department of Computer Science, Computer Vision and Geometry Group at ETH Zurich in Zurich, Switzerland.

In some embodiments, flight controller 102 can obtain an estimate for the attitude, position, velocity and acceleration of UAV 10 from additional sensors that can be integrated into flight controller 102, such as gyroscopes, accelerometers, barometers and magnetometers, and external to flight controller 102, such as global positioning system (“GPS”) devices, cameras, light detection and ranging (“LIDAR”) systems, and any other system or device that is obvious to those skilled in art in adding to UAV 10. In some embodiments, flight controller 102 can compare the estimate with user input and based on the flight mode of UAV 10, can calculate appropriate signals to send to the actuators.

In some embodiments, flight controller 102 can be operatively coupled to ESCs 106a to 106d via signal connections 112a to 112d that can each comprise a positive and negative power connection in addition to a signal connection “S”. In some embodiments, each S signal connection can comprise a pulse width modulated (“PWM”) signal to ESCs 106a to 106d. The output voltage supplied by ESCs 106a to 106d to control motors 32a to 32d can be proportional to the pulse width of the S signal supplied to ESCs 106a to 106d to control the rotational speed of motors 32a to 32d.

In some embodiments, flight controller 102 can be operatively coupled to ESCs 110a and 110b via signal connections 114a and 114b that can each comprise a positive and negative power connection in addition to the signal connection “S”. The output voltage supplied by ESCs 110a and 110b to rotor motors 20a and 20b can be proportional to the pulse width of the S signal supplied to ESCs 110a and 110b to control the rotational speed of motors 20a and 20b.

In some embodiments, flight controller 102 can be operatively connected to upper pitch servo motor 47 via pitch servo signal 116a, and to lower pitch servo motor 49 via pitch servo signal 116b. Servo signals 116a and 116b can comprise a PWM signal wherein the amount of angular movement of servo motors 47 and 49 can be proportional to the pulse width of servo signals 116a and 116b. As an example, when the pulse width of signal 116a or 116b is 1 millisecond, servo motor 47 or 49 can move to its respective 0° position. When the pulse width is 1.5 milliseconds, servo motor 47 or 49 can move to its respective 90° position. When the pulse width is 2 milliseconds, servo motor 47 or 49 can move to its respective 180° position.

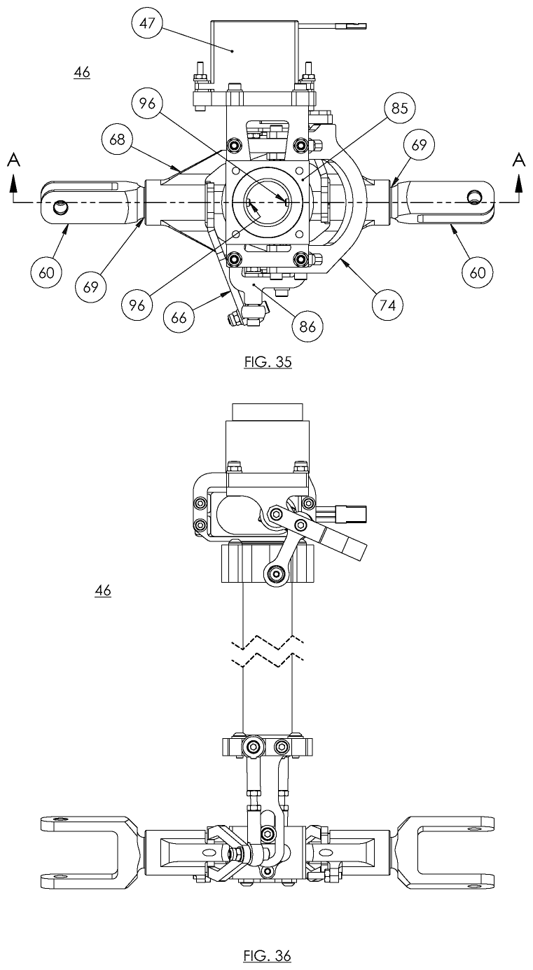

Referring to FIGS. 34 to 37, an alternate embodiment of upper pitch control mechanism 46 is shown. In this illustrated embodiment, upper pitch control mechanism can be similar in configuration to lower pitch control mechanism 48 except being inverted vertically and mounted above upper propeller 34.

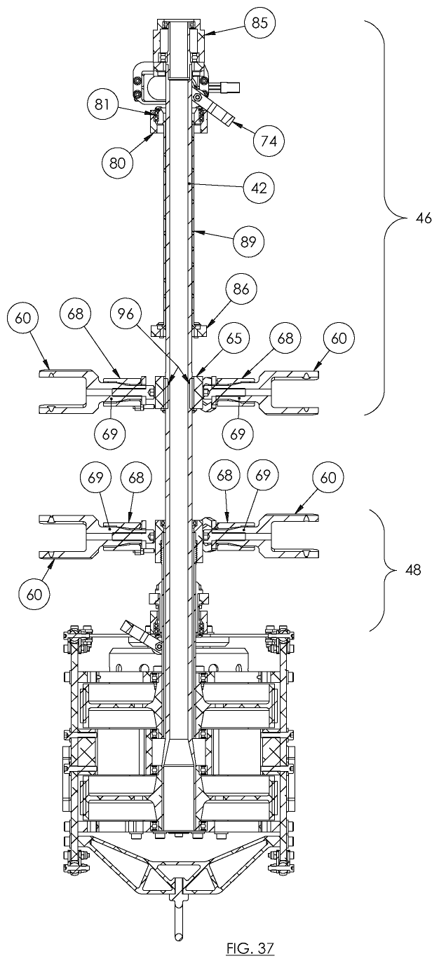

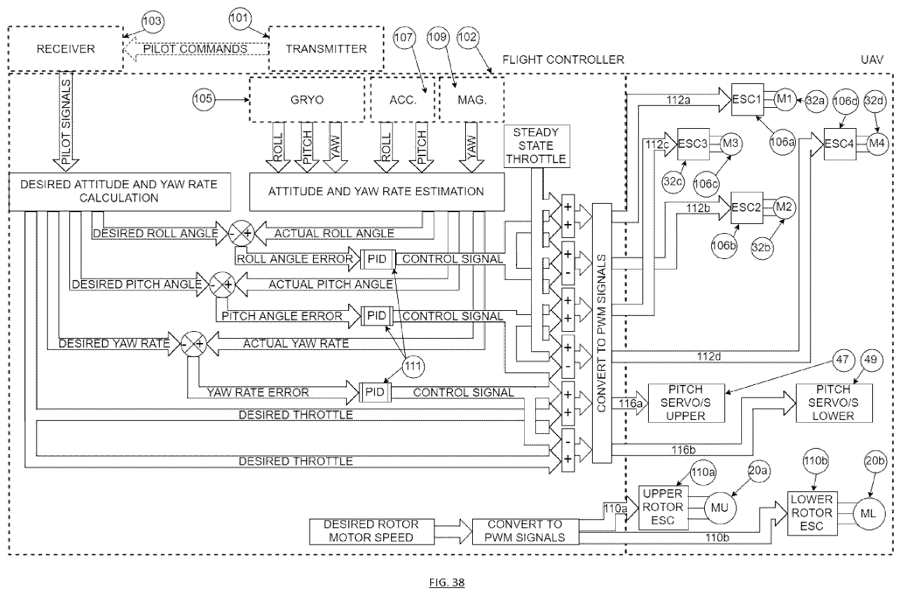

In some embodiments, upper pitch control mechanism 46 can comprise a pair of blade mounts 60, each comprising a shaft 69 rotatably disposed through rotor hubs 68, wherein each rotor hub 68 can, in turn, be hingeably attached to flapping hinges 70. Blade mounts 60 of upper pitch control mechanism 46 can be configured to receive blade rotors to form upper propeller 34. In this embodiment, upper pitch control mechanism can comprise upper ring bearing boss 85 and upper pitch sleeve 89 that enable upper pitch control mechanism 46 to be telescopably and slidably mounted on an upper end of upper output shaft 42, as shown in in FIG. 37. In some embodiments, keys 96 disposed in collar 65 can engage corresponding keyways disposed in upper output shaft 42 (not shown) thus operatively coupling upper output shaft 42 to collar 65.

In some embodiments, flapping hinges 70 can operatively couple rotor hubs 68 to collar 65 whereby rotation of upper output shaft 42 can rotate collar 65 and, thus, rotate upper propeller 34. In some embodiments, each blade mount 60 can be operatively coupled to shaft 69, which can then be operatively coupled to crank arm 66, which can further be coupled to control arm 86 via linkage 64. Control arm 86 can be operatively coupled to upper sleeve 89, which can be rotatably and slidably disposed around upper output shaft 42, wherein upper sleeve 89 can be rotatably attached to base 80 via bearing 81. Control arm 86 can be operatively coupled to guide support member 83 that can further comprise slot 82 for receiving guide pin 84 operatively attached to collar 65. Base 80 can be operatively coupled to one or more upper pitch servo motors 47 via lower crank 74 and links 76. Thus, upper pitch servo motors 47, upon receiving the first control signal, can rotate upper crank 74 to lower base 80 to lower control arm 86 via upper sleeve 89. In so doing, linkage 64 can push down on crank arms 66 to rotate shafts 69 thus increasing the pitch of the rotors of upper propeller 34 as it rotates clockwise, as shown in the illustrated embodiment. Similarly, upper pitch servo motors 47, upon receiving the second control signal, can rotate upper crank 74 to raise base 80 to raise control arm 86 via upper sleeve 89. In so doing, linkage 64 can pull up on crank arms 66 to rotate shafts 69 thus decreasing the pitch of the rotors of upper propeller 34.

Referring to FIG. 38, a block diagram of one embodiment of a flight control system or flight controller for use with UAV 10 is illustrated, represented by reference numeral 101. In some embodiments, a flight controller for use with drones, as well known to those skilled in the art, can be used, where the flight controller comprises a wireless transmitter 101 for transmitting command signals to UAV 10 by operating one or more thumbsticks or joysticks, switches, buttons and the like disposed on the transmitter. Using the thumbsticks on transmitter 101, a pilot can command a desired roll angle, pitch angle, yaw angular rate, and throttle for UAV 10. For example, for basic hovering, the pilot would command 0° roll angle, 0° pitch angle, 0°/s yaw angular rate, and the throttle necessary for hover, where transmitter 101 can transmit these signals wirelessly to wireless receiver 103. In some embodiments, receiver 103 can be a separate electronic unit disposed on UAV 10 that can operatively couple to flight controller 102 via a wired connection. In other embodiments, receiver 103 can be integrated into flight controller 102 as a functional component disposed therein.

In some embodiments, flight controller 102 can also receive information from onboard gyroscope 105, accelerometer 107 and magnetometer 109. Using information from these components, an estimation of the actual aircraft roll angle, pitch angle and yaw angular rate can be calculated. For each of the roll angle, pitch angle and yaw angular rate, an estimate of the error between the pilot commands and the actual aircraft angles and angular rates can be obtained by subtracting the desired value from the actual aircraft value.

In some embodiments, each error estimate can then be forwarded to a Proportional-Integral-Derivative (PID) controller 111, which can calculate the required signal for that direction (roll, pitch, yaw) to achieve the pilot's desired behaviour with acceptable responsiveness but minimal overshoot. These signals can then be ‘mixed’ to ensure that each actuator provides output of the correct magnitude and direction. For example, in a four-attitude control motor arrangement (where the 4 motors are spaced approximately 90° apart like the points on a compass), each motor is always sent a steady state throttle. Because each motor is opposed by an opposing motor, no net force or torque is applied to the aircraft. However, a roll torque may be induced on the aircraft by reducing the throttle signal sent to one control motor and increasing by the same amount the throttle signal sent to the opposing control motor. The same can be achieved for pitch by using the other pair of opposing control motors.

Likewise, both the upper and lower servomotors can be sent a signal equal to the pilot's desired throttle. To induce a yaw rate, the blade pitch of the upper rotor can be increased, and the blade pitch of the lower rotor can be decreased by an equal amount, or vice versa.

In some embodiments, the desired rotor motor speed can be pre-programmed, and can be held constant so that a consistent rotor speed can be is achieved. The signals can then be converted to a PWM signal (which can be interpreted by the actuators) and sent via a wired connection to each of the actuators.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments described herein.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

1. (canceled)

1. An unmanned aerial vehicle (“UAV”), comprising:
a) at least one motor operatively coupled to at least one propeller via at least one substantially vertical output shaft, the at least one propeller configured to provide vertical lift to the UAV when the at least one motor is operating, the at least one propeller comprising at least one rotor;
b) a support frame configured to support the at least one motor and the at least one propeller; and
c) a cage operatively coupled to the support frame, the cage configured to enclose the at least one propeller.

2. The UAV as set forth in claim 1, further comprising at least one attitude control motor disposed on an upper portion of the cage, the at least one attitude control motor configured to provide attitude thrust to the UAV.

3. The UAV as set forth in claim 2, wherein the at least one attitude control motor is configured to provide thrust in more than one attitude direction.

4. The UAV as set forth in claim 2, wherein the at least one attitude control motor further comprises three attitude control motors disposed on the upper portion, the three attitude control motors spaced substantially equidistant apart from each other.

5. The UAV as set forth in claim 2, wherein the at least one attitude control motor further comprises four attitude control motors disposed on the upper portion, the four attitude control motors spaced substantially equidistant apart from each other.

6. The UAV as set forth in claim 1, wherein the cage further comprises:
a) a lower ring operatively coupled to the support frame;
b) an upper ring disposed above the lower ring, the upper ring substantially co-axially aligned with the lower ring;
c) at least one guard ring disposed between the upper ring and the lower ring, the at least one guard ring substantially co-axially aligned with the upper and lower rings; and
d) a plurality of spokes operatively coupling the at least one guard ring to the upper ring and to the lower ring.

7. The UAV as set forth in claim 6, wherein the at least one guard ring comprises an upper guard ring and a lower guard ring spaced-apart from each other by a plurality of substantially vertical spaced-apart struts, and the plurality of spokes comprises a plurality of upper spokes operatively coupling the upper ring to the upper guard ring and a plurality of lower spokes operatively coupling the lower ring to the lower guard ring.

8. The UAV as set forth in claim 1, wherein the at least one motor comprises at least one internal combustion motor.

9. The UAV as set forth in claim 1, wherein the at least one motor comprises at least one electric motor.

10. The UAV as set forth in claim 9, further comprising at least one battery operatively coupled to the at least one electric motor.

11. The UAV as set forth inclaim 1, further comprising at least one pitch control mechanism operatively coupled to the at least one propeller, the at least one pitch control mechanism configured to adjust a pitch of the at least one rotor.

12. The UAV as set forth in claim 1, wherein the at least one propeller comprises an upper propeller disposed above a lower propeller, the upper propeller operatively coupled to an upper output shaft and the lower propeller operatively coupled to a lower output shaft, the upper output shaft substantially aligned and nested within the lower output shaft, the upper and lower propellers configured to rotate in opposite directions relative to each other.

13. The UAV as set forth in claim 12, further comprising an upper pitch control mechanism operatively coupled to the upper propeller.

14. The UAV as set forth in claim 13, wherein the upper pitch control mechanism comprises a pushrod disposed within the upper output shaft, the pushrod operatively coupled to an upper sleeve slidably disposed around the upper output shaft by a guide pin passing through slots disposed through sidewalls of the upper output shaft whereby the sleeve is configured to move up and down relative to the upper output shaft as the pushrod moves up and down, the sleeve operatively coupled to at least one upper rotor shaft configured to adjust the pitch of the upper propeller as the pushrod moves up and down.

15. The UAV as set forth in claim 12, further comprising a lower pitch control mechanism operatively coupled to the lower propeller.

16. The UAV as set forth in cairn 15, wherein the lower pitch control mechanism comprises a lower crank operatively coupled to a lower sleeve slidably disposed around the lower output shaft whereby the lower sleeve is configured to move up and down relative to the lower output shaft as the lower crank moves up and down, the lower sleeve operatively coupled to at least one lower rotor shaft configured to adjust the pitch of the lower propeller as the lower sleeve moves up and down.

17. The UAV as set forth in claim 1, wherein the support frame further comprises a motor plate operatively coupled to a first end of the at least one motor and at least one torque reaction arm operatively coupled to a second end of the at least one motor, the at least one torque reaction arm operatively coupled to the support frame by at least one linkage.
